(19) United States
(12) Patent Application Publication
(10) Pub. No.: US 2013/0209933 A1
(43) Pub. Date: Aug. 15, 2013

(54) RELEASE AGENT FOR TONER, AND TONER CONTAINING THE RELEASE AGENT

(71) Applicant: CANON KABUSHIKI KAISHA, (US)

(72) Inventor: Naotake Sato, Sagamihara-shi (JP)

(73) Assignee: CANON KABUSHIKI KAISHA, Tokyo (JP)

(21) Appl. No.: 13/725,033

(22) Filed: Dec. 21, 2012

(30) Foreign Application Priority Data
Feb. 9, 2012 (JP) 2012-025701

(51) Int. Cl. G03G 9/125; G03G 9/00

(52) U.S. Cl. CPC G03G 9/125; G03G 9/00
USPC 430/115; 430/112

(57) ABSTRACT

An object of the present invention is to provide a toner release agent adaptable to making the fixing temperature of the toner low. The above object can be solved by using a release agent for a toner including a hydrophobic organic substance which is liquid at normal temperature and normal pressure and has a relative dielectric constant of 20 or lower and an SP value of lower than 10, and a gelling agent.

### BACKGROUND OF THE INVENTION

1. Field of the Invention

The present invention relates to a release agent for a toner, and a toner with the release agent.

2. Description of the Related Art

The energy saving and the speeding-up are the performances demanded for electrophotographic devices. One of the effective ways to achieve the energy saving and the speeding-up is making the toner fixing temperature low. The toner fixing temperature can be lowered by making the melting point of a release agent low. The chemical structures of the release agents have been devised to lower the melting points (Japanese Patent Application Laid-Open No. 2007-57869, Japanese Patent Application Laid-Open No. H10-83097). However, the polymerization reaction, the esterification, the ureation reaction and the like are required in order to synthesize the low-melting point release agents of the above documents. Furthermore, in addition to the chemical reactions, refining is necessary for the synthesis. As a result, the number of processes to synthesize the low-melting point release agents becomes large and a large amount of industrial wastes is generated.

The present inventors have paid attention to that the use of a gelling agent enables the preparation of a release agent having a different melt property without complex processes.

A liquid and a gelling agent are mixed and dissolved, and caused to form a crosslinked three-dimensional network, and can mimically be solidified. The reaction is called the gelation reaction. The gelation reaction needs a smaller number of processes and generates a remarkably smaller amount of wastes than the chemical synthesis.

The gelation reaction has been used broadly from old. For example, in food industries, as described in Japanese Patent Application Laid-Open No. H08-283305, the gelation reaction has been applied to production of jelly, tofu (bean curd) and konjak (devil's-tongue) jelly. Further in cosmetic industries, as described in International Journal of Cosmetic Science 2010, 32, 246-257, the gelation reaction has been applied to production of cosmetic foundations, moisturizing agents and the like. Further as described in Japanese Patent Application Laid-Open No. 2000-219849, the gelation reaction has been applied to production of car waxes, oil absorbing materials and the like. In these fields, the gelation reaction has been used mainly for the purpose of the fluidity control (viscosity regulation).

The crosslinking formation conducting the gelation reaction is broadly classified into following two types. One type is “chemical gel” in which one-dimensional fibrous molecules are linked through covalent bonds, and the other is “physical gel” in which these are linked through noncovalent bonds.

Although the chemical gel is high in stability because of utilizing the covalent bond, the chemical gel is a macromolecule and is hardly solubilized. By contrast, the physical gel does not necessarily need to be a macromolecule because of utilizing the noncovalent bond, and is sensitive to the temperature change and the stress impression.

Japanese Patent Application Laid-Open No. 2001-109187 proposes a toner containing a macromolecular gelling agent as a main component. The invention aims at the suppression of image contamination due to toner scattering, carrier liquid leakage and the like, and the downsizing of toner particles to make high image quality.

In the present invention, the gelation reaction is applied to release agent for a toner. That is, in the present invention, by utilizing features of the gelling agent, a novel release agent has been created. In the present invention, suitably setting the kind and the addition amount of a gelling agent enables control of the melt behavior. The present invention pays attention to that since a gelated substance exhibits thixotropy, the viscosity can be reduced not only by heating but also by pressure impression. In the release agent according to the present invention, the temperature to reduce the fluidity can be more efficiently reduced; and in the fixation process of electrophotography, the release agent can be melted at a lower temperature and also by pressure impression. In the present invention, either gelling agent of a physical gel and a chemical gel can be used.

### SUMMARY OF THE INVENTION

It is an object of the present invention to provide a release agent for a toner adaptable to making the fixing temperature of the toner low.

The present invention relates to a release agent for a toner including:

i) a hydrophobic organic substance which is liquid at normal temperature and normal pressure and has a relative dielectric constant of 20 or lower, and

ii) a gelling agent.

Further features of the present invention will become apparent from the following description of exemplary embodiments.

### DESCRIPTION OF THE EMBODIMENTS

Preferred embodiments of the present invention will now be described in detail.

First, a release agent will be described in detail. In the present invention, normal temperature means 25° C., and normal pressure means 1 atm.

<Release Agent>

The release agent for a toner according to the present invention includes a hydrophobic organic substance which is liquid at normal temperature and normal pressure and has a relative dielectric constant of 20 or lower, and a gelling agent.

The hydrophobic organic substance specifically includes ester or ether compounds, ketone compounds, alcohol compounds, fatty acids, hydrocarbons and silicone oils, and these can be used singly or as a mixture thereof. Particularly a hydrophobic organic substance having low volatility can be used from the viewpoint of the stability of the compositional ratio after gelation.

The melting point (gel point) of a release agent prepared by the present invention can be selected suitably according to the purpose, but can be 40 to 160° C., is more preferably 50 to 120° C., and especially preferably 60 to 90° C., from the viewpoint of satisfaction of both the heat-resistive preservability and the low-temperature fixability.

The relative dielectric constant refers to a ratio ∈/∈₀=∈ᵣ of a dielectric constant of a medium and a dielectric constant of vacuum, but is utilized also in the case of evaluating the polarity of a chemical substance.

Since a substance having a high relative dielectric constant has a large polarity, the substance has a high affinity for a polar material, for example, water (relative dielectric constant: 80), methanol (relative dielectric constant: 33), N,N-dimethylformamide (DMF, relative dielectric constant: 38) or dimethyl sulfoxide (DMSO, relative dielectric constant: 47). Therefore, a substance having a high relative dielectric constant has a very high solubility to water, and can form a homogeneous solution in any proportion. Such a compound lacks releasability from a fixing member. By contrast since a substance having a low relative dielectric constant has a small polarity, the substance has a high affinity for a nonpolar material, for example, hexane (relative dielectric constant: 2.0, solubility to water: 1 g/L or lower (20° C.)), ethyl acetate (relative dielectric constant: 6.4, solubility to water: 83 g/L (20° C.)) and 1-butanol (relative dielectric constant: 17.8, solubility to water: 77 g/L (20° C.)). Such a substance is excellent in releasability from a fixing member. Therefore, an organic substance having a relative dielectric constant of 20 or lower like the latter substances has a more preferable property as a release agent for a toner.

However, even If the relative dielectric constant is 20 or lower, a hydrophilic organic substance exists like tetrahydrofuran (THF, relative dielectric constant: 7.5) and acetic acid (relative dielectric constant: 6.2). Since these organic substances are hydrophilic, these lack releasability.

Therefore, in order to fully satisfy the performance as a release agent for a toner, the organic substance needs to have a relative dielectric constant of 20 or lower, and besides simultaneously exhibit the hydrophobicity.

Examples of specific hydrophobic organic substances are as follows.

Ester Compound

As an ester, well-known esters can be used as represented by the form of R—COO—R′ (R denotes a hydrogen atom or an organic group such as an alkyl group or an aryl group; and R′ denotes an organic group such as an alkyl group or an aryl group) as their structural formula. If the ester is a general ester, the relative dielectric constant is about 7.5 to 3.0. An ester can be used in which R and R′ have 1 to 22 consecutive carbon atoms. The ester specifically includes n-butyl stearate (relative dielectric constant: 3.1) and n-butyl butyrate (relative dielectric constant: 5.1). However, the ester is not limited to the above ester raw materials, and can be used as long as being liquid at normal temperature and normal pressure, and being a hydrophobic ester having a relative dielectric constant of 20 or lower.

Ether Compound

As an ether, well-known ethers can be used as represented by the form of R—O—R′ (R and R′ denote an organic group such as an alkyl group having 1 to 8 carbon atoms or an aryl group) as their structural formula. If the ether is a general ether, the relative dielectric constant is about 3.0 to 5.0. The ether specifically includes di(n-pentyl ether) (relative dielectric constant: 3.1) and n-propyl ethyl ether (relative dielectric constant: 4.0). However, the ether is not limited to the above ethers, and can be used as long as being liquid at normal temperature and normal pressure, and being a hydrophobic ether having a relative dielectric constant of 20 or lower.

Ketone Compound

As a ketone, well-known ketones can be used as represented by the form of R—CO—R′ (R and R′ denote an organic group such as an alkyl group having about 1 to 8 carbon atoms or an aryl group) as their structural formula. If the ketone has a general structure, the relative dielectric constant of any ketone is about 12 to 19. The ketone specifically includes 2-hexanone (relative dielectric constant: 12.5) and n-decanone (relative dielectric constant: 12.0). However, the ketone is not limited to the above ketones, and can be used as long as being liquid at normal temperature and normal pressure, and being a hydrophobic ketone having a relative dielectric constant of 20 or lower.

Alcohol Compound

As an alcohol, well-known alcohols can be used as represented by the form of R—OH(R denotes an organic group such as an alkyl group having about 1 to 18 carbon atoms or an aryl group) as their structural formula. If the alcohol has a general structure, the relative dielectric constant of any alcohol is about 4.0 to 19.0. The alcohol specifically includes 1-dodecanol (relative dielectric constant: 6.5) and 1-octadecanol (relative dielectric constant: 5.0). However, the alcohol is not limited to the above alcohols, and can be used as long as being liquid at normal temperature and normal pressure, and being a hydrophobic alcohol having a relative dielectric constant of 20 or lower.

Fatty Acid

As a fatty acid, well-known fatty acids can be used as represented by the form of R—COOH (R denotes an organic group such as an alkyl group having about 1 to 17 carbon atoms or an aryl group) as their structural formula. If the fatty acid has a general structure, the relative dielectric constant of any fatty acid is about 2.5 to 9.0. The fatty acid specifically includes linseed oil (relative dielectric constant: 3.1 to 3.5) and soybean oil (relative dielectric constant: 2.9 to 3.2). However, the fatty acid is not limited to the above fatty acids, and can be used as long as being liquid at normal temperature and normal pressure, and being a hydrophobic fatty acid having a relative dielectric constant of 20 or lower.

Hydrocarbon

As a hydrocarbon, well-known fatty acids and cyclic hydrocarbons can be used. A general hydrocarbon has a relative dielectric constant of about 1.5 to 6.0. The hydrocarbon specifically includes dodecane (relative dielectric constant: 1.8) and octadecane (relative dielectric constant: 1.7). The hydrocarbon can be used as long as being liquid at normal temperature and normal pressure, and being a hydrophobic hydrocarbon having a relative dielectric constant of 20 or lower.

Silicone Oil

As a silicone oil, well-known silicone oils can be used. The silicone oil specifically includes silicone oils such as dimethylpolysiloxane, diphenylpolysiloxane and phenylmethylsiloxane; and reactive silicone oils such as amino-modified polysiloxane, epoxy-modified polysiloxane, carboxyl-modified polysiloxane, carbinol-modified polysiloxane, methacryl-modified polysiloxane, mercapto-modified polysiloxane and phenol-modified polysiloxane. The silicone oil can be used as long as being liquid at normal temperature and normal pressure, and being a hydrophobic silicone oil having a relative dielectric constant of 20 or lower.

(Gelling Agent)

The present invention can utilize either gelation reaction of chemical gel and physical gel. Therefore, a gelling agent usable is either of a gelling agent forming a chemical gel (hereinafter, chemical gel-forming material) and a gelling agent forming a physical gel (hereinafter, physical gel-forming material).

First, the chemical gel-forming material will be described in detail.

The chemical gel-forming material needs to have a skeleton by covalent bonds, and specifically includes block copolymers of styrene and butadiene. In the case of such a type of a polymer, since butadiene is crosslinked in a styrene polymer, a three-dimensional network structure is structured. By incorporating a hydrophobic organic substance which is liquid at normal temperature and normal pressure and has a relative dielectric constant of 20 or lower into this structure, a mimic solid state can be maintained.

Then, the physical gel-forming material will be described in detail. Since the physical gel-forming material needs to form crosslinking points by noncovalent bonds, the physical gel-forming material can be a physical gel-forming material having nonpolar sites having 4 or more atoms connected in the molecule, and polar sites capable of forming hydrogen bonds. The physical gel-forming material specifically includes aliphatic carboxylic acid derivatives and benzylidene sorbitol derivatives having 4 or more atoms connected in the molecule. Other Examples thereof include organic substances having nonpolar sites and polar sites, like sterol derivatives having a long-chain alkyl group and naphthalenic acid derivatives having a long-chain alkyl group. Further in the case of organic acids like aliphatic carboxylic acids, the addition of metal ions enables the formation of a physical gel.

The above physical gel-forming material can structure a three-dimensional network structure by the interaction between nonpolar sites in the molecule and the interaction between polar sites in the molecule. By incorporating a hydrophobic organic substance which is liquid at normal temperature and normal pressure and has a relative dielectric constant of 20 or lower into this structure, a mimic solid state can be maintained.

Hereinafter, a method for preparing a release agent for a toner will be described in detail.

(Method for Preparing a Release Agent for a Toner)

A method for preparing the release agent according to the present invention is as follows.

The release agent for a toner according to the present invention can be prepared by adding the gelling agent to the hydrophobic organic substance which is liquid at normal temperature and normal pressure and has a relative dielectric constant of 20 or lower, heating the mixture, stirring the mixture until the mixture becomes a homogeneous solution, and thereafter slowly cooling the solution.

The addition amount of a gelling agent can be in the range of 0.1% by mass to 50% by mass. If the addition amount is in this range, the sufficient mechanical strength as a release agent can be secured and the sufficient performance as a release agent for a toner can be provided. However, since the operation of the addition amount of a gelling agent enables the operation of the melt property as a release agent for a toner, there is no need for the complex operation like the melt property control operated by the conventional chemical synthesis such as polymerization and esterification. Also the generation amount of wastes can be made smaller than in the chemical synthesis.

Besides the above preparation method, a release agent for a toner can be prepared also by adding the solutionized gelling agent to a hydrophobic organic substance, fully stirring and dispersing the mixture and allowing the dispersion to stand still. The feature of this method lies in no need of heating operation because the gelling agent before being added is dissolved in a solvent, and added. Thereby, the preparation process can be lightened more. Also in this method, the addition amount of a gelling agent can be in the range of 0.1% by mass to 50% by mass with respect to the hydrophobic organic substance.

A release agent for a toner can be prepared also by the emulsion aggregation method. Specifically, a release agent can be prepared by adding the hydrophobic organic substance and a gelling agent in water, and heating and emulsifying the mixture, or developing a homogeneous solution, in which a solutionized gelling agent is added in the hydrophobic organic substance in water, and emulsifying the mixture.

The content of a release agent with respect to a toner particle is not especially limited, and can be selected suitably according to the purpose, but can be 1 to 40% by mass, and is more preferably 3 to 30% by mass of the toner particle, from the viewpoint of satisfaction of both the fluidity and the releasability.

The melting point of the above-mentioned release agent is not especially limited, and can be selected suitably according to the purpose, but can be 40 to 160° C., and is more preferably 50 to 120° C., and especially preferably 60 to 90° C. If the melting point is lower than 40° C., the release agent adversely affects the heat-resistive preservability in some cases; and if the melting point exceeds 160° C., the release agent is liable to cause cold offset on fixation at low temperatures in some cases.

Then, components other than a release agent contained in a toner will be described. In the present specification, a toner particle referred to as is a toner on whose surface no external additive such as silica is adhered, and a toner referred to as is a toner on whose surface an external additive such as silica is adhered.

<Binding Resin>

A binding resin can be selected suitably from well-known binding resins according to the purpose. The binding resin includes, for example, homopolymers of styrene and substitution products thereof such as polystyrene, poly(p-chlorostyrene) and polyvinyltoluene, styrenic copolymers such as styrene-p-chlorostyrene copolymers, styrene-propylene copolymers, styrene-vinyltoluene copolymers, styrene-methyl acrylate copolymers, styrene-ethyl acrylate copolymers, styrene-methacrylic acid copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ether copolymers, styrene-vinyl methyl ketone copolymers, styrene-butadiene copolymers, styrene-isoprene copolymers and styrene-maleic acid copolymers, polymethyl methacrylate, polybutyl methacrylate, polyvinyl chloride, polyvinyl acetate, polyethylene, polyester, polyurethane, epoxy resins, polyvinyl butyral, polyacrylic acids, rosins, modified rosins, terpene resins, phenol resins, aliphatic or aromatic hydrocarbon resins and aromatic petroleum resins. These binding resins can be used singly or as a mixture of two or more.

The glass transition temperature (Tg) of a binding resin in the present invention can be 30° C. or higher and 70° C. or lower, and is more preferably 40° C. or higher and 60° C. or lower. In some cases of the glass transition temperature of 30° C. or lower, a toner poses a problem such as of being liable to cause blocking. By contrast, if the glass transition temperature is higher than 70° C., since the fixing temperature rises along with the high glass transition temperature, a problem arises in some cases, from the viewpoint of the low-temperature fixability.

The glass transition temperature (Tg) of a binding resin is a value measured at a temperature-rising rate of 3° C./min according to the method (DSC method) prescribed in ASTM D3418-82.

<Coloring Agent>

A coloring agent usable in the present invention is not especially limited, and includes well-known coloring agents, and can be selected suitably according to the purpose. The coloring agent may be used singly, or as a mixture of two or more coloring agents of the same type, or as a mixture of two or more coloring agents of different types. These coloring agents may further be surface-treated and used.

Specific examples of the coloring agents are black, yellow, orange, red, blue, purple, green, white and other coloring agents as shown below.

Examples of black pigments are organic and inorganic coloring agents such as carbon black, aniline black, active carbon, nonmagnetic ferrite and magnetite.

Examples of yellow pigments are Chrome Yellow, Zinc Yellow, Yellow Calcium Oxide, Cadmium Yellow, Chrome Yellow, Fast Yellow, Fast Yellow 5G, Fast Yellow 5GX, Fast Yellow 10G, Benzidine Yellow G, Benzidine Yellow GR, Threne Yellow, Quinoline Yellow and Permanent Yellow NCG.

Examples of orange pigments are Red Chrome Yellow, Molybdenum Orange, Permanent Orange GTR, Pyrazolone Orange, Vulcan Orange, Benzidine Orange G, Indathrene Brilliant Orange RK and Indathrene Brilliant Orange GK.

Examples of red pigments are Iron Oxide Red, Cadmium Red, Red Lead, mercury sulfide, Watch Young Red, Permanent Red 4R, Lithol Red, Brillian Carmine 3B, Brillian Carmine 6B, Dupont Oil Red, Pyrazolone Red, Rhodamine B Lake, Lake Red C, Rose Bengal, Eoxine Red and Alizarin Lake.

Examples of blue pigments are organic and inorganic coloring agents such as Berlin Blue, Cobalt Blue, Alkali Blue Lake, Victoria Blue Lake, Fast Sky Blue, Indathrene Blue BC, Ultra Marine Blue, Phthalocyanine Blue and Phthalocyanine Green.

Examples of purple pigments are organic and inorganic coloring agents such as Manganese Purple, Fast Violet B and Methyl Violet Lake.

Examples of green pigments are organic and inorganic coloring agents such as chrome oxide, Chrome Green, Pigment Green B, Malachite Green Lake and Fanal Yellow Green G.

Examples of white pigments are Zinc White, titanium oxide, Antimony White and zinc sulfide.

Examples of extenders are baryta powder, barium carbonate, clay, silica, white carbon, talc and alumina white.

<External Additives>

External additives such as a fluidizing agent and a charge control agent may be added to the toner according to the present invention. As an external additive, well-known materials can be used, including inorganic particles such as silica particles whose surface has been surface-treated, titanium oxide particles, alumina particles, cerium oxide particles and carbon black, polymer particles such as of polycarbonate, polymethyl methacrylate and silicone resins, amine metal salts, and metal salicylate complexes. The external additives used in the present invention may be used singly or concurrently in two or more.

[Method for Producing a Toner Particle]

In a method for preparing the toner particle according to the present invention, the toner particle can be prepared by a so-called chemical production method in which a resin particle dispersion liquid is prepared using the binding resin, and a toner is prepared from the resin particle dispersion liquid. In the present invention, this method is called a dispersion liquid aggregation method.

A method for preparing the toner particle according to the present invention can be a method including a process of aggregating binding resin particles in a dispersion liquid containing at least the binding resin particle to thereby obtain an aggregated particle (hereinafter, “aggregation process”), and a process of heating and fusing the aggregated particle (hereinafter, “fusion process”).

In the present invention, the particle can be prepared by generating aggregation by the pH change in the aggregation process. Simultaneously in order to aggregate stably and rapidly particles, or obtain aggregated particles having a narrower particle distribution, an aggregating agent may be added.

<Method for Preparing a Resin Particle Dispersion Liquid of a Binding Resin>

A method for dispersing and particulating a binding resin in an aqueous medium is selected also from well-known methods such as the forced emulsification method, the self-emulsification method and the phase inversion emulsification method. Above all, the self-emulsification method and the phase inversion emulsification method are preferably applied in consideration of the energy necessary for the emulsification, the particle size controllability and stability of the emulsified material obtained, and the like.

For example, in the case of the phase inversion emulsification method, first, a binding resin is dissolved in a single or mixed solvent of amphipathic organic solvent(s). A basic substance is dropped in the resin solution while the resin solution is stirred using a well-known stirrer, emulsifying machine, dispersing machine or the like; and thereafter, an aqueous medium is dropped while the resin solution is stirred; thereby, at some time point, an oil phase and a water phase inverse and the oil phase becomes oil droplets. Thereafter, the dispersion liquid is subjected to a solution removal process under reduced pressure to thereby obtain an aqueous dispersion liquid in which the binding resin is dispersed.

Here, the amphipathic organic solvent refers to an amphipathic organic solvent having a solubility at 20° C. to water of 5 g/L or higher, more preferably 10 g/L or higher. If the solubility is lower than 5 g/L, there arises a problem that the particle diameter becomes coarse and large, and the aqueous dispersion liquid obtained is inferior in storage stability.

Examples of the above-mentioned amphipathic organic solvents are alcohols such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol and cyclohexanol; ketones such as methyl ethyl ketone, methyl isobutyl ketone, ethyl butyl ketone, cyclohexanone and isophorone; ethers such as tetrahydrofuran and dioxane; esters such as ethyl acetate, acetic acid-n-propyl, isopropyl acetate, acetic acid-n-butyl, isobutyl acetate, acetic acid-sec-butyl, acetic acid-3-methoxybutyl, methyl propionate, ethyl propionate, diethyl carbonate and dimethyl carbonate; glycol derivatives such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monopropyl ether, diethylene glycol monobutyl ether, diethylene glycol ethyl ether acetate, propylene glycol, propylene glycol monomethyl ether, propylene glycol monopropyl ether, propylene glycol monobutyl ether, propylene glycol methyl ether acetate and dipropylene glycol monobutyl ether; and further, 3-methoxy-3-methylbutanol, 3-methoxybutanol, acetonitrile, dimethylformamide, dimethylacetamide, diacetone alcohol and ethyl acetoacetate. These solvents can be used singly or as a mixture of two or more.

The basic substance suffices if being an inorganic or organic basic compound, and includes, for example, inorganic bases such as ammonia, sodium hydroxide, potassium hydroxide, sodium carbonate, potassium carbonate, sodium hydrogencarbonate and potassium hydrogencarbonate, and organic bases such as methylamine, dimethylamine, trimethylamine, ethylamine, diethylamine, triethylamine, dimethylaminoethanol, diethylaminoethanol, sodium succinate and sodium stearate. Above all, amines such as dimethylamine, triethylamine and dimethylaminoethanol can be used from the viewpoint of not causing the hydrolysis.

The addition amount of the basic substance can be regulated suitably so that the pH on dispersion and mixing becomes nearly neutral. The basic substance is likely to make the particle diameter of an obtained binding resin microparticle small as the addition amount is increased. In the case of using a strong base as a basic substance, and in the case where the binding resin is polyester or polyurethane, the addition amount needs to be limited so as not to cause the hydrolysis. From such a viewpoint, the amount of a basic substance to be used can be 0.20 to 2.50 equivalents, is more preferably 0.35 to 2.00, and is still more preferably 0.50 to 1.75, with respect to an acidic polar group of a binding resin.

These basic substances may be used singly or concurrently in two or more. A basic substance may be used as it is, but may be mixed with an aqueous medium as a form of a solution for homogeneous addition.

For example, in the case where the binding resin is the vinylic polymer, an aqueous dispersion of a binding resin microparticle is prepared by dispersing the vinylic polymer, as a binding resin, for which a well-known polymerization method such as the emulsion polymerization, the miniemulsion polymerization or the seed polymerization has been used suitably, in an aqueous medium.

Since the toner particle diameter is generally about 3 to 8 μm, in order to keep the compositional uniformity of the toner prepared through an aggregation process and a fusion process described later, the particle diameter of a binding resin microparticle dispersed in an aqueous medium can be a 50% particle diameter (d50) of 0.5 μm or smaller in terms of volume distribution, and is more preferably a 90% particle diameter (d90) of 1 μm or smaller in terms of volume distribution. Here, the dispersed particle diameter of a binding resin (1) can be measured by a particle size distribution analyzer (Coulter Multisizer III, made by Beckman Coulter, Inc.) using the Doppler scattering-type particle size analysis Coulter method, or other instruments.

A well-known stirrer, emulsifying machine and dispersing machine used in dispersion of a binding resin include, for example, an ultrasonic homogenizer, a jet mill, a pressure-type homogenizer, a colloid mill, a ball mill and a sand mill, and these may be used singly or in combination of two or more.

A dispersion liquid of the coloring agent can be prepared by the following well-known methods, but the methods are not limited thereto.

The dispersion liquid can be prepared, for example, by mixing a coloring agent, an aqueous medium and a dispersant by a well-known stirrer, emulsifying machine, dispersing machine or the like. A dispersant to be used here may be a well-known one such as a surfactant or a polymer dispersant, or may be one synthesized newly for the present invention. Although any dispersant can be removed in a toner cleaning process described later, a surfactant described later is more preferable from the viewpoint of cleaning efficiency; and among surfactants, anionic surfactants, nonionic surfactants and the like can be used. The amount of a dispersant to be mixed can be 1 to 20 parts by mass, and from the viewpoint of satisfaction of both the dispersion stability and the toner cleaning efficiency, is more preferably 2 to 10 parts by mass, with respect to 100 parts by mass of a coloring agent. The content of a coloring agent in a coloring agent water-dispersion liquid is not especially limited, but can be about 1 to 30% by mass to the total mass of the coloring agent water-dispersion liquid. The particle diameter of a coloring agent dispersed in an aqueous medium can be a 50% particle diameter (d50) of 0.5 μm or smaller in terms of volume distribution, and is more preferably a 90% particle diameter (d90) of 2 μm or smaller in terms of volume distribution, from the viewpoint of the pigment dispersibility of a toner finally obtained. Here, the dispersed particle diameter of a coloring agent can be measured by a particle size distribution analyzer (Coulter Multisizer III, made by Beckman Coulter, Inc.) using the Coulter method, or other instruments.

A well-known stirrer, emulsifying machine and dispersing machine used in dispersion of a coloring agent include, for example, an ultrasonic homogenizer, a jet mill, a pressure-type homogenizer, a colloid mill, a ball mill, a sand mill and a paint shaker, and these may be used singly or in combination of two or more.

The surfactant includes, for example, anionic surfactants such as sulfate ester salt-based, sulfonate salt-based, phosphate ester-based and soap-based anionic surfactants; cationic surfactants such as amine salt types and quarternary ammonium salt types; and nonionic surfactants such as polyethylene glycol-based, alkylphenol ethylene oxide addition product-based and polyhydric alcohol-based nonionic surfactants. Above all, nonionic surfactants and/or anionic surfactants can be used. Nonionic surfactants may be used concurrently used with anionic surfactants. The surfactants may be used singly or concurrently in two or more. The concentration of the surfactant in an aqueous medium can be made to be about 0.5 to 5% by mass.

<Method for Preparing a Coloring Agent Dispersion Liquid>

A method for preparing the toner according to the present invention involves, in the case where the preparation method of the toner is an emulsion polymerization aggregation method, dispersing a coloring agent with a dispersant such as a surfactant in an aqueous medium by mechanical impact or the like to thereby prepare a coloring agent dispersion liquid, and causing the dispersion liquid to aggregate with a resin particle and the like to be thereby granulated into a toner particle diameter.

Specific examples of coloring agent dispersion using mechanical impact or the like involves preparation of a dispersion liquid of a coloring agent particle using, for example, a media-type dispersing machine such as a rotary shearing-type homogenizer, a ball mill, a sand mill or an attritor, or a high-pressure counter-impact type dispersing machine. The coloring agent is dispersed in aqueous medium by a homogenizer using a surfactant having a polarity in some cases.

A coloring agent can be added in the range of 4 to 15% by mass, and is added more preferably in the range of 4 to 10% by mass, with respect to the total mass of the solid content of a toner, in order to secure the color developability on fixation. However, in the case of using a magnetic substance as a black coloring agent, the addition amount can be in the range of 12 to 48% by mass, and is more preferably 15 to 40% by mass. Suitable selection of the kind of the coloring agent can provide a toner of each color such as yellow, magenta, cyan, black, white or green.

<Method for Preparing a Release Agent Dispersion Liquid>

The toner according to the present invention can be dispersed using a well-known method. A release agent dispersion liquid can be prepared, for example, by adding a release agent prepared from a hydrophobic organic substance having a relative dielectric constant of 20 or lower at normal temperature and a gelling agent to an aqueous medium containing a surfactant, heating the mixture at a temperature equal to or higher than the melting point of the release agent, and simultaneously particulately dispersing the release agent by a homogenizer having a strong shear-imparting power (for example, “Clearmix W Motion”, made by M Technique Co., Ltd.) or a pressure discharge-type dispersing machine (for example, “Gaulin Homogenizer”, made by SMT Co., Ltd.), and cooling the dispersion liquid to a temperature equal to or lower than the melting point.

The 50% particle diameter D50 in terms of volume distribution of the release agent dispersion liquid can be 80 to 500 nm, and is more preferably 100 to 300 nm. No presence of coarse and large particles of 600 nm or larger is preferable. If the dispersed particle diameter is in the above range, the elution of the release agent on fixation is good while the exposure of the release agent to the toner surface can be suppressed. The dispersed particle diameter can be measured by a particle size distribution analyzer (Coulter Multisizer III, made by Beckman Coulter, Inc.) using the Coulter method, or other instruments.

The proportion of a surfactant to a release agent in a release agent dispersion liquid can be 1% by mass or higher and 20% by mass or lower. If the proportion of a surfactant is in the above range, the dispersion of a release agent becomes good, and the excellent preservation stability can be provided. Also good properties for the environmental stability can be provided.

The release agent is added in 1 to 30 parts by mass to 100 parts by mass of a binding resin.

<Aggregating Agent>

The aggregating agent can be a compound having a mono- or higher valent charge, and specific examples thereof include water-soluble surfactants such as the above-mentioned ionic surfactants and nonionic surfactants; acids such as hydrochloric acid, sulfuric acid, nitric acid, acetic acid and oxalic acid; metal salts of inorganic acids such as magnesium chloride, sodium chloride, aluminum chloride (including polyaluminum chloride), aluminum sulfate, calcium sulfate, ammonium sulfate, aluminum nitrate, silver nitrate, copper sulfate and sodium carbonate; metal salts of aliphatic acids and aromatic acids such as sodium acetate, potassium formate, sodium oxalate, sodium phthalate, and potassium salicylate, metal salts of phenols such as sodium phenolate, metal salts of amino acid, and inorganic acid salts of aliphatic and aromatic amines such as triethanolamine hydrochloride and aniline hydrochloride.

If the stability of the aggregated particles, the stability of an aggregating agent to heat and the lapse of time, and the removal of the aggregating agent in cleaning are taken into account, the aggregating agent can be a metal salt of an inorganic acid, which is preferable in the point of the performance and usage. The aggregating agent specifically includes metal salts of inorganic acids such as magnesium chloride, sodium chloride, aluminum chloride (including polyaluminum chloride), aluminum sulfate, ammonium sulfate, aluminum nitrate, silver nitrate, copper sulfate and sodium carbonate.

The addition amount of the aggregating agent, although depending on the valence number of the charge, is a small amount in any valence; in the case of monovalence, the amount can be 3% by mass or smaller with respect to the total amount of a toner; in the case of divalence, 1% by mass or smaller; and in the case of trivalence, 0.5% by mass or smaller. Since a smaller amount of an aggregating agent is preferable, a compound having a large valence number can be used as an aggregating agent.

(Method for Preparing a Toner)

An aggregation method in the aggregation process is not especially limited, and an aggregation method used in the conventional emulsion polymerization aggregation method of a toner, for example, a method of reducing the stability of an emulsion by temperature raising, pH change, salt addition and the like, and stirring by a dispersing machine or the like, is used.

In the aggregation process, for example, particles in a resin particle dispersion liquid, a coloring agent dispersion liquid, and as required, a release agent dispersion liquid, which have been mutually mixed, aggregate to be thereby able to form aggregated particles of a toner particle diameter. The aggregated particle is formed of heteroaggregation and the like, and for the purpose of the stabilization of the aggregated particle, and the control of the particle size/particle distribution, an ionic surfactant having a different polarity from the aggregated particle, and a compound having a mono- or higher valent charge such as a metal salt are added in some cases.

In the aggregation process, the particle diameter and distribution of a toner can be regulated by polymerizing a monomer in oil droplets emulsified and dispersed in a water phase in the presence of a polymerization initiator to make a resin polymer particle, and then aggregating (associating) the formed polymer particle with a particle containing at least a coloring agent particle (in the case where a coloring agent is in advance added to a resin in the polymerization process, the resin itself is a coloring particle) by a well-known aggregation method.

Suitably, the preparation of a toner particle in the emulsion polymerization aggregation method is used. In detail, a toner particle is obtained by mixing an obtained resin particle dispersion liquid with a coloring agent particle dispersion liquid, a release agent particle dispersion liquid and the like, further adding an aggregating agent to the mixture to thereby generate heteroaggregation to form aggregated particles of a toner diameter, and thereafter heating the aggregated particles at a temperature equal to or higher than the glass transition temperature or the melting point of the resin particle to thereby fuse and unify the aggregated particles and cleaning and drying the resultant. This production method controls the toner shape from spherical to indeterminate by selecting the heating temperature condition.

In the aggregation process, processes following aggregation can also be carried out by mixing two or more kinds of resin particle dispersion liquids. In this case, a particle can be multi-layered by in advance aggregating a resin particle dispersion liquid to thereby form a first aggregated particle, and thereafter further adding another resin particle dispersion liquid to thereby form a second shell layer on the first aggregated particle surface, or by other methods. A multi-layered particle can be of course prepared in the reverse order to the above example.

The used surfactant and the like may be removed by water cleaning, acid cleaning, alkali cleaning or the like, as required.

A desired toner may be obtained through an optional cleaning process, solid-liquid separation process and drying process after the completion of the aggregation process and the fusion process. The cleaning process can be carried out by carrying out sufficient replace-cleaning by an ion-exchange water from the viewpoint of chargeability. The solid-liquid separation process is not especially limited, but suction filtration, pressurized filtration or the like can be used from the viewpoint of productivity. The drying process also is not especially limited, but freeze drying, flash jet drying, fluidized drying, vibration fluidized drying or the like can be used from the viewpoint of productivity.

<Aggregation Process>

Then, an aggregating agent is added and mixed in the mixed dispersion liquid obtained in the preceding process, and suitably impressed with heating, a mechanical power and the like to thereby form an aggregated particle.

As the aggregating agent, a di- or higher valent metal salt, a polymer thereof or the like can suitably be used. A di- or higher valent metal salt and a polymer thereof have the high cohesive force, and the addition of a small amount thereof ionically neutralizes the acidic group of the binding resin, and ionic surfactants in a binding resin dispersion liquid, a coloring agent dispersion liquid and a release agent dispersion liquid, and aggregates particles by effects of salting out and ionic crosslinking. The di- or higher valent metal salt and a polymer thereof specifically include divalent inorganic metal slats such as calcium chloride, calcium nitrate, magnesium chloride, magnesium sulfate and zinc chloride; trivalent metal salts such as iron(III) chloride, iron(III) sulfate, aluminum sulfate and aluminum chloride, and inorganic metal salt polymers such as polyaluminum chloride, polyaluminum hydroxide and calcium polysulfide, but are not limited thereto. These may be used singly or concurrently in two or more.

The aggregating agent may be added in either form of a dried powder and an aqueous solution in which the aggregating agent is dissolved in an aqueous medium, but can be added in the form of an aqueous solution, in order to cause uniform aggregation. The addition and mixing of the aggregating agent can be carried out at a temperature equal to or lower than the glass transition temperature of a binding resin contained in the mixed liquid. If the mixing is carried out under this temperature condition, the aggregation uniformly progresses. The mixing can be carried out using a well-known mixing device, a homogenizer, a mixer or the like.

In the aggregation process, well-known materials other than the above such as a charge control agent may be added. In this case, the volume-average particle diameter of a material to be added needs to be 1 μm or smaller, and can be 0.01 to 1 μm. If the volume-average particle diameter exceeds 1 μm, the particle diameter distribution of an obtained toner particle becomes broad, and free particles caused by the material result in being generated. The dispersed particle diameter can be measured by a particle size distribution analyzer (Coulter Multisizer III, made by Beckman Coulter, Inc.) using the Doppler scattering-type particle size analysis Coulter method, or other instruments.

Units to prepare a dispersion liquid of the adding materials is not especially limited, but includes well-known dispersion devices, for example, a rotary shearing-type homogenizer, and a ball mill, sand mill and Dynomill having media, and other devices similar to the devices in the preparation of the release agent dispersion liquid, and can be selected optimally according to the material.

The average particle diameter of the aggregated particle formed here is not especially limited, but may be usually so controlled as to be nearly equal to the average particle diameter of a toner to be finally obtained. The particle size control of an aggregated particle can easily be carried out by suitable settings and alterations of, for example, the temperature, the solid content concentration, the concentration of an aggregating agent, and the condition of stirring.

(Toner) A toner may be singly used and made a one-component developing agent, or combined with a carrier and made a two-component developing agent.

The carrier is not especially limited, but includes magnetic material particles such as iron powder, ferrite, iron oxide powder and nickel; resin-coated carriers in which the surface of a magnetic material particle as a core material is coated with a resin such as a styrenic resin, a vinylic resin, an ethylenic resin, a rosin-based resin, a polyesteric resin, or a melamine-based resin, or a wax such as stearic acid to thereby form a resin-coating layer; and magnetic material-dispersed carriers in which a magnetic material particle is dispersed in a binding resin. Above all, the resin-coated carrier is especially preferable because of being capable of controlling the chargeability of a toner and the resistance of the carrier as a whole by the constitution of the resin-coating layer.

The mixing proportion of a toner and a carrier in a two-component developing agent can be 2 to 10 parts by mass of a toner with respect to 100 parts by mass of a carrier. A method for preparing an electrostatic charge image developing agent is not especially limited, but includes, for example, a method of mixing by a V blender or the like.

(Method for Forming Images)

The electrostatic charge image developing agent (electrostatic charge image developing toner) is used in a method for forming images of a usual electrostatic charge image developing system (electrophotography).

The method for forming images according to the present invention can generally include a charging process of charging an image holder, a latent image forming process of forming electrostatic latent images on the image holder surface, a developing process of developing the electrostatic latent images formed on the image holder surface to form a toner image, a transferring process of transferring the toner image formed on the image holder surface to the surface of a body to be transferred on, and a fixing process of heating the toner image to fix the toner image. The method, as required, may include a cleaning process.

### EXAMPLES

Hereinafter, the present invention will be described in detail by way of Examples and Comparative Examples, but the scope of the present invention is not limited thereto. Every operation was carried out at normal temperature and normal pressure.

First, a method for preparing the release agent for a toner according to the present invention will be described.

(Preparation of a Release Agent Microparticle Dispersion Liquid 1)

20 parts by mass of butyl stearate (relative dielectric constant: 5.4, melting point: 17 to 22° C., SP value: 7.4 (cal/cm³)^{1/2}) and 2.0 parts by mass of 1,3:2,4-bis-O-benzylidene-D-glucitol (made by New Japan Chemical Co., Ltd., Gelol D (benzylidene sorbitol derivative)) together with a dispersion medium liquid constituted of 1 part by mass of an anionic surfactant (made by Daiichi Kogyo Seiyaku Co., Ltd., Neogen RK) and 170 parts by mass of an ion exchange water were charged in a 350-ml pressure-proof round-bottom stainless steel vessel. Then, a high-speed shearing emulsifying apparatus, Clearmix (made by M Technique Co., Ltd., CLM-2.2S) was hermetically connected to the pressure-proof round-bottom stainless steel vessel. The mixture in the vessel was dispersed by shearing at a Clearmix rotor frequency of 10,000 r/min for 30 min while being heated and pressurized at 80° C. and 0.18 MPa. Thereafter, the resultant was cooled at a cooling rate of 5.0° C./min down to 30° C. while the rotation was maintained at 5,000 r/min, to thereby obtain a release agent microparticle dispersion liquid 1.

The median diameter in terms of volume of the release agent microparticle as measured by a dynamic light scattering-type particle size distribution analyzer (Nanotrack, made by Nikkiso Co., Ltd.) was 0.25 p.m.

(Preparation of a Release Agent Microparticle Dispersion Liquid 2)

A release agent microparticle dispersion liquid 2 was obtained by the same method as in the preparation of the release agent microparticle dispersion liquid 1, except for altering butyl stearate described therein to dioctyl ether (relative dielectric constant: 3.1, melting point: −7° C., SP value: 8.2 (cal/cm³)^{1/2}). The median diameter in terms of volume of the obtained release agent microparticle was 0.22 μm.

(Preparation of a Release Agent Microparticle Dispersion Liquid 3)

A release agent microparticle dispersion liquid 3 was obtained by the same method as in the preparation of the release agent microparticle dispersion liquid 1, except for altering butyl stearate described therein to 2-decanone (relative dielectric constant: 12.0, melting point: 3.5° C., SP value: 8.5 (cal/cm³)^{1/2}). The median diameter in terms of volume of the obtained release agent microparticle was 0.32 μm.

(Preparation of a Release Agent Microparticle Dispersion Liquid 4)

A release agent microparticle dispersion liquid 4 was obtained by the same method as in the preparation of the release agent microparticle dispersion liquid 1, except for altering butyl stearate described therein to 1-dodecanol (relative dielectric constant: 6.5, melting point: 23° C., SP value: 9.8 (cal/cm³)^{1/2}). The median diameter in terms of volume of the obtained release agent microparticle was 0.25 μm.

(Preparation of a Release Agent Microparticle Dispersion Liquid 5)

A release agent microparticle dispersion liquid 5 was obtained by the same method as in the preparation of the release agent microparticle dispersion liquid 1, except for altering butyl stearate described therein to linolenic acid (relative dielectric constant: 2.5, melting point: −11° C., SP value: 9.2 (cal/cm³)^{1/2}). The median diameter in terms of volume of the obtained release agent microparticle was 0.28 μm.

(Preparation of a Release Agent Microparticle Dispersion Liquid 6)

A release agent microparticle dispersion liquid 6 was obtained by the same method as in the preparation of the release agent microparticle dispersion liquid 1, except for altering butyl stearate described therein to dodecane (relative dielectric constant: 2.3, melting point: −12° C., SP value: 7.8 (cal/cm³)^{1/2}). The median diameter in terms of volume of the obtained release agent microparticle was 0.30 μm.

(Preparation of a Release Agent Microparticle Dispersion Liquid 7)

A release agent microparticle dispersion liquid 7 was obtained by the same method as in the preparation of the release agent microparticle dispersion liquid 1, except for altering butyl stearate described therein to a dimethylsilicone oil (relative dielectric constant: 2.6, melting point: −50° C. or lower, SP value: 7.1 (cal/cm³)^{1/2}). The median diameter in terms of volume of the obtained release agent microparticle was 0.35 μm.

(Preparation of a Release Agent Microparticle Dispersion Liquid 8)

A release agent microparticle dispersion liquid 8 was obtained by the same method as in the preparation of the release agent microparticle dispersion liquid 1, except for altering 1,3:2,4-bis-O-benzylidene-D-glucitol (made by New Japan Chemical Co., Ltd., Gelol D (benzylidene sorbitol derivative)) described therein to aluminum distearate (made by Kawamura Kasei Industry Co., Ltd., Aluminum Stearate #32Veg). The median diameter in terms of volume of the obtained release agent microparticle was 0.20 μm.

(Preparation of a Release Agent Microparticle Dispersion Liquid 9)

A release agent microparticle dispersion liquid 9 was obtained by the same method as in the preparation of the release agent microparticle dispersion liquid 1, except for altering 1,3:2,4-bis-O-benzylidene-D-glucitol (made by New Japan Chemical Co., Ltd., Gelol D (benzylidene sorbitol derivative)) described therein to calcium stearate (made by Kawamura Kasei Industry Co., Ltd.). The median diameter in terms of volume of the obtained release agent microparticle was 0.34 μm.

(Preparation of a Release Agent Microparticle Dispersion Liquid 10)

A release agent microparticle dispersion liquid 10 was obtained by the same method as in the preparation of the release agent microparticle dispersion liquid 1, except for altering 1,3:2,4-bis-O-benzylidene-D-glucitol (made by New Japan Chemical Co., Ltd., Gelol D (benzylidene sorbitol derivative)) described therein to a 30% xylene solution of calcium stearate (made by Kawamura Kasei Industry Co., Ltd.). The median diameter in terms of volume of the obtained release agent microparticle was 0.34 μm.

(Preparation of a Release Agent Microparticle Dispersion Liquid 11)

A release agent microparticle dispersion liquid 11 was obtained by the same method as in the preparation of the release agent microparticle dispersion liquid 1, except for altering 1,3:2,4-bis-O-benzylidene-D-glucitol (made by New Japan Chemical Co., Ltd., Gelol D (benzylidene sorbitol derivative)) described therein to a styrene-butadiene block copolymer (αGel-1000, made by Alpha Japan Inc.). The median diameter in terms of volume of the obtained release agent microparticle was 0.54 μm.

(Preparation of a Release Agent Microparticle Dispersion Liquid 12)

A release agent microparticle dispersion liquid 12 was obtained by the same method as in the preparation of the release agent microparticle dispersion liquid 1, except for altering the amount of 1,3:2,4-bis-O-benzylidene-D-glucitol (made by New Japan Chemical Co., Ltd., Gelol D (benzylidene sorbitol derivative)) described therein from 2 parts by mass to 1.5 parts by mass. The median diameter in terms of volume of the obtained release agent microparticle was 0.52 μm.

(Preparation of a Release Agent Microparticle Dispersion Liquid 13)

A release agent microparticle dispersion liquid 13 was obtained by the same method as in the preparation of the release agent microparticle dispersion liquid 1, except for altering the amount of 1,3:2,4-bis-O-benzylidene-D-glucitol (made by New Japan Chemical Co., Ltd., Gelol D (benzylidene sorbitol derivative)) described therein from 2 parts by mass to 1.0 part by mass. The median diameter in terms of volume of the obtained release agent microparticle was 0.50 μm.

(Preparation of a Release Agent Microparticle Dispersion Liquid 14)

A release agent microparticle dispersion liquid 14 was obtained by the same method as in the preparation of the release agent microparticle dispersion liquid 1, except for altering the amount of 1,3:2,4-bis-O-benzylidene-D-glucitol (made by New Japan Chemical Co., Ltd., Gelol D (benzylidene sorbitol derivative)) described therein from 2 parts by mass to 0.7 part by mass. The median diameter in terms of volume of the obtained release agent microparticle was 0.52 μm.

(Preparation of a Release Agent Microparticle Dispersion Liquid 15)

A release agent microparticle dispersion liquid 15 was obtained by the same method as in the preparation of the release agent microparticle dispersion liquid 1, except for altering butyl stearate described therein to nitrobenzene (relative dielectric constant: 26.3, melting point: 5 to 6° C., SP value: 10.0 (cal/cm³)^{1/2}). The median diameter in terms of volume of the obtained release agent microparticle was 0.34 μm.

(Preparation of a Release Agent Microparticle Dispersion Liquid 16)

A release agent microparticle dispersion liquid 16 was obtained by the same method as in the preparation of the release agent microparticle dispersion liquid 1, except for altering butyl stearate described therein to 1,2-ethylene glycol monomethyl ether (relative dielectric constant: 30.1, melting point: −68° C., SP value: 12.2 (cal/cm³)^{1/2}). The median diameter in terms of volume of the obtained release agent microparticle was 0.28 μm.

(Preparation of a Release Agent Microparticle Dispersion Liquid 17)

A release agent microparticle dispersion liquid 17 was obtained by the same method as in the preparation of the release agent microparticle dispersion liquid 1, except for altering butyl stearate described therein to 1,2-diethylene glycol dimethyl ether (relative dielectric constant: 33.1, SP value: 11.3 (cal/cm³)^{1/2}). The median diameter in terms of volume of the obtained release agent microparticle was 0.30 μm.

(Preparation of a Release Agent Microparticle Dispersion Liquid 18)

A release agent microparticle dispersion liquid 18 was obtained by the same method as in the preparation of the release agent microparticle dispersion liquid 1, except for altering butyl stearate described therein to dimethylformamide (relative dielectric constant: 37.0, melting point: −61° C., SP value: 12.0 (cal/cm³)^{1/2}). The median diameter in terms of volume of the obtained release agent microparticle was 0.30 μm.

Then, a method for preparing a toner using the release agent according to the present invention will be described.

A Method for Preparing a Toner

(Preparation of a Resin Microparticle Dispersion Liquid 1 for a Toner Particle)

A dispersion medium liquid was prepared by dissolving 0.15 g of a sulfonic acid-based anionic surfactant (made by Daiichi Kogyo Seiyaku Co., Ltd., Neogen RK) and 3.15 g of N,N-dimethylaminoethanol (basic substance) in 146.70 g of an ion exchange water (aqueous medium). The dispersion medium liquid was charged in a 350-ml pressure-proof round-bottom stainless steel vessel; and then, 150 g of a crushed material (diameter: 1 to 2 mm) of a “polyester resin A” was charged and mixed, the composition (molecular ratio) of the polyester resin A being polyoxypropylene(2.2)-2,2-bis(4-hydroxyphenyl)propane:polyoxyethylene(2.0)-2,2-bis(4-hydroxyphenyl)propane:terephthalic acid:fumaric acid:trimellitic acid=25:25:26:20:4 and having Mn: 3,500, Mw: 10,300, Mw/Mn: 2.9, Tm: 96° C., Tg: 56° C., and an acid value of 12 mg KOH/g.

Then, a high-speed shearing emulsifying apparatus, Clearmix (made by M Technique Co., Ltd., CLM-2.2S) was hermetically connected to the pressure-proof round-bottom stainless steel vessel. The mixture in the vessel was dispersed by shearing at a Clearmix rotor frequency of 18,000 r/min for 30 min while being heated and pressurized at 115° C. and 0.18 MPa. Thereafter, the resultant was cooled at a cooling rate of 2.0° C./min down to 50° C. while the rotation was maintained at 18,000 r/min, to thereby obtain a dispersion 1 of the resin microparticle. The median diameter in terms of volume of the obtained resin microparticle as measured by a dynamic light scattering-type particle size distribution analyzer (Nanotrack, made by Nikkiso Co., Ltd.) was 0.22 μm.

(Preparation of a Coloring Agent Microparticle Dispersion Liquid)

A cyan pigment (made by Dainichiseika Color & Chemicals Mfg. Co., Ltd., Pigment Blue 15:3): 100 parts by mass

An anionic surfactant (made by Daiichi Kogyo Seiyaku Co., Ltd., Neogen RK): 15 parts by mass

An ion exchange water: 885 parts by mass

The aboves were mixed and melted, and dispersed for about 1 hour using a high pressure impact-type dispersing machine, Nanomizer (made by Yoshida Kikai Co., Ltd.) to thereby prepare a coloring agent microparticle dispersion liquid in which the coloring agent was dissolved. The median diameter in terms of volume of the obtained coloring agent microparticle as measured by a dynamic light scattering-type particle size distribution analyzer (Nanotrack, made by Nikkiso Co., Ltd.) was 0.20 μm.

Preparation of a Toner Particle Dispersion Liquid 1

The followings were dispersed using a homogenizer (made by IKA-Werke GmbH & Co. KG, Ultra Turrax T50), and thereafter heated to 45° C. in a heating water bath under stirring by a stirring blade.
The dispersion 1 of the resin microparticle: 40 parts by mass
The coloring agent microparticle dispersion liquid: 10 parts by mass
The release agent microparticle dispersion liquid 1:20 parts by mass
A 1-mass % magnesium sulfate aqueous solution: 20 parts by mass
An ion exchange water: 140 parts by mass

After the resultant was held at 45° C. for 1 hour, the resultant was observed by an optical microscope, and it was confirmed that aggregated particles having an average particle diameter of about 5.5 μm were formed. 40 parts by mass of a 5-mass % trisodium citrate aqueous solution was added to the resultant, which was thereafter heated up to 85° C. and held for 120 min under continuous stirring to be thereby fused into toner particles. Then, the resultant was cooled to 25° C. in a water bath under continuous stirring to thereby obtain a toner particle dispersion liquid 1.

The median diameter in terms of volume of the particle diameter of the toner particle as measured by a particle size distribution analyzer (Coulter Multisizer III, made by Beckman Coulter, Inc.) using the Coulter method was 5.5 μm.

Preparation of a Toner Particle Dispersion Liquid 2 to 18

Toner particle dispersion liquids 2 to 18 were obtained by the same method as in the preparation of the toner particle dispersion liquid 1, except for using respective release agent microparticle dispersion liquids shown in Table 1. The particle diameters of the toner particles were measured by a particle size distribution analyzer (Coulter Multisizer III, made by Beckman Coulter, Inc.) using the Coulter method, and the results are shown in Table 1.

TABLE 1

| | | Toner Particle |
|---|---|---|
| Toner Particle | Release Agent | Diameter (median |
| Dispersion | Microparticle | diameter in terms of |
| Liquid No. | Dispersion Liquid No. | volume; μm) |
| 1 | 1 | 5.5 |
| 2 | 2 | 5.4 |
| 3 | 3 | 5.4 |
| 4 | 4 | 5.7 |
| 5 | 5 | 5.5 |
| 6 | 6 | 5.6 |
| 7 | 7 | 5.4 |
| 8 | 8 | 5.6 |
| 9 | 9 | 5.5 |
| 10 | 10 | 5.6 |
| 11 | 11 | 5.5 |
| 12 | 12 | 5.2 |
| 13 | 13 | 5.9 |
| 14 | 14 | 5.1 |
| 15 | 15 | 5.9 |
| 16 | 16 | 5.8 |
| 17 | 17 | 5.8 |
| 18 | 18 | 5.9 |

### Example 1

1,000 g of the toner particle dispersion liquid 1 was charged in a tall beaker, and stirred by a stirring blade at 25° C. in a heating water bath. Then, a 2-mass % calcium chloride aqueous solution was slowly dropped therein.

In this state, a small amount of the liquid was on occasion extracted, and passed through a 2-μm microfilter; and the liquid was continuously stirred at 25° C. until the filtrate became transparent. After it was confirmed that the filtrate became transparent, the liquid was heated to 40° C., and 133 g of a 5-mass % trisodium citrate aqueous solution was added to the liquid, which was then heated to 65° C., and stirred for 1.5 hours. Thereafter, the obtained liquid was cooled to 25° C., and filtrated and solid-liquid separated; and thereafter, 800 g of an ion exchange water was added to the solid content, and stirred for cleaning for 30 min. Thereafter, the filtration and solid-liquid separation was again carried out. As described above, the filtration and the cleaning were repeated until the electroconductivity of the filtrate became 150 μS/cm or lower, in order to eliminate the influence of the remaining surfactant. Then, the obtained solid content was dried to thereby obtain a cyan toner particle of Example 1. The median diameter in terms of volume of the obtained cyan toner particle was 5.6 μm.

100 parts by mass of the toner particle dried in a 40° C. oven was mixed with 1.5 parts by mass of a hydrophobic silica (RX50, made by Nippon Aerosil Co., Ltd., average particle diameter: 40 nm) and 0.8 part by mass of a hydrophobic titania (P25, made by Nippon Aerosil Co., Ltd., major axis 50 nm×minor axis 21 nm) by a Henschel mixer, to thereby obtain a cyan toner 1.

### Examples 2 to 14, and Comparative Examples 1 to 4

Toners 2 to 18 for cyan electrostatic charge image development were obtained by the same method as in Example 1, except for altering the toner particle dispersion liquid 1 described in Example 1 to respective toner particle dispersion liquids shown in Table 2.

Evaluations of the Toners

The following evaluations were carried out using the above toners 1 to 18. The results are shown in Table 2.

(Evaluation of Heat-Resistive Storage)

100 parts by mass of each toner particle was mixed with 1.5 parts by mass of a hydrophobic silica (RX50, made by Nippon Aerosil Co., Ltd., average particle diameter: 40 nm) and 0.8 part by mass of a hydrophobic titania (P25, made by Nippon Aerosil Co., Ltd., major axis 50 nm×minor axis 21 nm) by a Henschel mixer, to thereby obtain an externally-adding toner for cyan electrostatic charge image development. The each externally-adding toner was allowed to stand still for 24 hours in a thermostatic chamber whose temperature was conditioned at 56° C., which was the same as the glass transition temperature (Tg) of the binding resin (polyester resin A) of the each toner particle, and visually evaluated for the degree of blocking. The evaluation results are shown in Table 2.

The evaluation standard of the heat-resistive storage was: the case where no blocking occurred was taken as “A”; the case where blocking occurred but was easily dispersed by light vibration was taken as “B”; the case where blocking occurred but was dispersed under continuous vibration was taken as “C”; and the case where blocking occurred and was not dispersed even if a force was impressed was taken as “D”.

(Evaluation of Fixability)

The each externally-adding toner and a ferrite carrier (average particle diameter: 42 μm) surface-coated with a silicone resin were mixed so that the toner concentration became 6% by mass to thereby prepare a two-component developing agent. An unfixed toner image (0.6 mg/cm²) was formed on an image-receiving paper (64 g/m²) using a commercially available full-color digital copying machine (CLC1100, made by Canon Corp.). A fixing test of the unfixed image was carried out using a fixing unit dismounted from a commercially available color laser printer (LBP-5500, made by Canon Corp.) and remodeled so as to regulate the fixing temperature. The situation of offset was visually evaluated when the unfixed image was fixed under the conditions of at normal temperature and normal humidity, at a process speed set at 100 mm/sec, and at 17 temperatures set at intervals of 5° C. in the range of from 110° C. to 190° C. The evaluation results are shown in Table 2.

The evaluation content involved two points of the lower-limit fixing temperature and the fixability at 140° C. The case where the lower-limit fixing temperature could not be evaluated, that is, where a sufficient releasing effect did not develop, was taken as “D”. The evaluation standard of the fixability at 140° C. was: the case where zero offset point occurred was taken as “A”; the case of 3 points or less, as “B”; and the case of 6 points or more, as “D”.

It is found from the results of Example 1 to Example 7 shown in Table 2 that even by using hydrophobic organic substances which were liquid at normal temperature and normal pressure, and had a relative dielectric constant of 20 or lower and an SP value of lower than 10 as a raw material, release agents could be prepared using the same gelling agent, and a variety of lower-limit fixing temperatures could be regulated. It is also found from the results of Example 8 to Example 11 that even by using the same hydrophobic organic substances which were liquid at normal temperature and normal pressure, and had a relative dielectric constant of 20 or lower and an SP value of lower than 10 as a raw material, the lower-limit fixing temperature could be controlled by selecting combinations with various types of gelling agents. It is further found from the results of Example 12 to Example 14 that by regulating the addition amount of the gelling agent, the lower-limit fixing temperature could be controlled.

It is found from Comparative Example 1 to Comparative Example 4 that in the case of organic substances being liquid at normal temperature but having a relative dielectric constant exceeding 20, even if the release agent was mimically solidified with the gelling agent, the release agent did not satisfy the properties as a toner release agent.

TABLE 2

| | | | | Fixability Evaluation | |
|---|---|---|---|---|---|
| | | Toner | | Lower-Limit | |
| | | Particle | Heat- | Fixing | |
| | Toner | Dispersion | Resistive | Temperature | Fixability |
| | No. | Liquid No. | Storage | ° C. | at 140° C. |
| Example 1 | 1 | 1 | A | 130° C. | B |
| Example 2 | 2 | 2 | B | 125° C. | A |
| Example 3 | 3 | 3 | B | 125° C. | B |
| Example 4 | 4 | 4 | A | 130° C. | C |
| Example 5 | 5 | 5 | B | 125° C. | B |
| Example 6 | 6 | 6 | B | 115° C. | A |
| Example 7 | 7 | 7 | B | 110° C. | A |
| Example 8 | 8 | 8 | A | 115° C. | A |
| Example 9 | 9 | 9 | A | 120° C. | B |
| Example 10 | 10 | 10 | A | 110° C. | A |
| Example 11 | 11 | 11 | A | 130° C. | B |
| Example 12 | 12 | 12 | B | 130° C. | B |
| Example 13 | 13 | 13 | B | 120° C. | B |
| Example 14 | 14 | 14 | C | 110° C. | B |
| Comparative | 15 | 15 | B | D | C |
| Example 1 | | | | | |
| Comparative | 16 | 16 | C | D | D |
| Example 2 | | | | | |
| Comparative | 17 | 17 | D | D | D |
| Example 3 | | | | | |
| Comparative | 18 | 18 | D | D | D |
| Example 4 | | | | | |

The release agent can be utilized as a toner release agent for electrostatic charge image development.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-25701, filed Feb. 9, 2012, which is hereby incorporated by reference herein in its entirety.

What is claimed is:

1. A release agent for a toner comprising:
i) a hydrophobic organic substance being liquid at normal temperature and normal pressure and having a relative dielectric constant of 20 or lower, and
ii) a gelling agent.

2. The release agent for a toner according to claim 1, wherein the hydrophobic organic substance is a compound selected from the group consisting of esters, ethers, ketones, alcohols, fatty acids, hydrocarbons and silicone oils.

3. The release agent for a toner according to claim 1, wherein the gelling agent has a structure having a nonpolar site containing 4 or more carbon atoms and a polar site capable of hydrogen bonding bonded to each other site.

4. The release agent for a toner according to claim 1, wherein the gelling agent is an aliphatic carboxylic acid derivative having 4 or more carbon atoms or a benzylidene sorbitol derivative.

5. A toner containing a release agent for a toner according to claim 1.
